(19) United States
(12) Patent Application Publication
(10) Pub. No.: US 2006/0208889 A1
(43) Pub. Date: Sep. 21, 2006

(54) Automated contacting of support centers and sharing of product information via RFID

(75) Inventors: Shmuel Shaffer, Palo Alto, CA (US); Labhesh Patel, Mountain View, CA (US); Gebran Chahrouri, Menlo Park, CA (US); Shantanu Sarkar, San Jose, CA (US); Bruce Moon, Dublin, CA (US); Joseph Khouri, San Jose, CA (US)

Correspondence Address: BEYER WEAVER & THOMAS, LLP, P.O. BOX 70250, OAKLAND, CA, 94612-0250, US

(73) Assignee: Cisco Technology, Inc.

(21) Appl. No.: 11/078,927

(22) Filed: Mar. 10, 2005

(51) Int. Cl. G08B 13/14; G06F 17/00

(52) U.S. Cl. 340/572.1; 235/375

(57) ABSTRACT

Disclosed are methods and apparatus for methods and apparatus for automatically contacting a service center for one or more particular products, as well as contacting other types of entities with respect to any type of item. In a first embodiment, each item includes a radio frequency identification (RFID) of the particular products that is used to automatically contact a service center or the like. In a second embodiment, the RFID of the particular product is automatically sent to the service center or the like. In the first embodiment, the RFID of each product contains contact information, such as a 1-800 telephone number, a URL address, or email address, for a particular service center or the like. In one implementation, an RFID reader is coupled with a communication device, such as a telephone or computer device, and the user uses the RFID reader to scan an RFID of a particular item (e.g., a malfunctioning product). The relevant service center or the like is then contacted based on the RFID scan. For example, the user is connected to an agent at the relevant service center via a telephone or computer network. In the second embodiment, when a service center (or the like) needs RFID tag data for a particular item, a user may select a “send” option (e.g., on the communication device or reader) to have such RFID tag data automatically transmitted to the service center or the like.

### BACKGROUND OF THE INVENTION

The present invention relates to techniques for contacting support centers that provide services for a particular product. It also relates to sharing product information with such support centers.

When a user has a problem or a question regarding a particular product, he or she typically has to first determine which service center to contact to obtain help. Locating the correct service center is not always an easy task. The user may have to conduct a time-consuming search in order to locate his or her original paperwork. The user may also need to perform an extensive search on the web for a 1-800 phone number, URL of the phone based or web based service center, or a particular service department that may provide support for the particular product.

Once the correct service center is located, other problems may arise for the person who is initiates communication with the service center. When a user calls a particular service department of an authorized dealership, for example, the call center agent usually asks the caller for the model number and serial number of his or her particular product. Obtaining this number could be difficult for certain people (e.g., elders) due to the small print and obscure locations manufacturers use to place the product serial number. Also, this identifying information may have become worn and unreadable over a long period of time.

In view of the above, there is a need for improved mechanisms for more easily contacting a service center for a particular product. Additionally, mechanisms for facilitating the providing of product information to a support center are also desired.

### SUMMARY OF THE INVENTION

Accordingly, the present invention provides methods and apparatus for automatically contacting a service center for one or more particular products, as well as contacting other types of entities with respect to any type of item. In a first embodiment, each item includes a radio frequency identification (RFID) of the particular products that is used to automatically contact a service center or the like. In a second embodiment, the RFID of the particular product is automatically sent to the service center or the like. In the first embodiment, the RFID of each product contains contact information, such as a 1-800 telephone number, a URL address, or email address, for a particular service center or the like. In one implementation, an RFID reader is coupled with a communication device, such as a telephone or computer device, and the user uses the RFID reader to scan an RFID of a particular item (e.g., a malfunctioning product). The relevant service center or the like is then contacted based on the RFID scan. For example, the user is connected to an agent at the relevant service center via a telephone or computer network. In the second embodiment, when a service center (or the like) needs RFID tag data for a particular item, a user may select a “send” option (e.g., on the communication device or reader) to have such RFID tag data automatically transmitted to the service center or the like.

In one embodiment, a method of automatically contacting a support center for a particular item using the radio frequency identification (RFID) of the particular item is disclosed. RFID tag data for a item is read using a radio frequency identification (“RFID”) reader. A service center that provides service for the item is automatically contacted based on the reading of the RFID tag data for the item. In a further aspect, RFID tag data for a plurality of items that are proximate to the RFID reader are read. A selection input for one or more read item(s) is received. A service center that provides service for the selected one or more read item(s) is automatically contacted based on the reading of the RFID tag data for the selected one or more read item(s).

In a specific implementation, automatically contacting the service center is accomplished by connecting a communication device accessible by a user with an agent of the service center via a telephone network or a computer network. The communication device includes or is coupled with the RFID reader. In a further aspect, automatically contacting the service center is accomplished by performing one or more of the following tasks (i) automatically dialing a phone number of the service center, (ii) automatically loading a web page of the service center, (iii) automatically sending an email message to the service center, and (iv) automatically establishing an instant messaging session between the user and an agent of the service center.

In another implementation, when the service center makes a request for RFID tag data, the RFID tag data that was read for the item is automatically sent to the service center. In a further aspect, the RFID tag data is only sent after a user selects an option to send the RFID tag data. In yet another aspect, the service center is allowed control of a menu of the communication device and the RFID reader after the user grants permission for such control.

In another embodiment, the invention pertains to a computer system operable to automatically contact a support center for a particular item using the radio frequency identification (RFID) of the particular item. The computer system includes one or more processors and one or more memory. At least one of the memory and processors are adapted to provide at least some of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagrammatic representation of a network in which techniques of the present invention may be implemented in accordance with one embodiment of the present invention.

FIG. 2 is a flowchart illustrating a procedure for automatically contacting a service center and automatically conveying RFID tag data to such service center in accordance with one implementation of the present invention.

FIG. 3A is a flowchart illustrating an example of actions performed by a user interacting with an RFID enabled communicator.

FIG. 3B illustrates an RFID-enabled communication device in the form of a telephone in accordance with a specific implementation of the present invention.

FIGS. 3C-3E illustrate different menus displayed on the telephone of FIG. 3B in accordance with a specific implementation of the present invention.

FIG. 4 is a diagrammatic representation of an RFID tag.

FIG. 5A illustrates an RFID-enabled communication device in the form of a telephone suitable for implementing portions of the present invention.

FIG. 5B illustrates an RFID-enabled communication device in the form of a computer system suitable for implementing portions of the present invention.

### DETAILED DESCRIPTION OF SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general terms, the present invention provides mechanisms for using the RFID tag data of an item, such as a consumer product, to automatically contact a service center (or any other suitable type of entity) for such item. A communication device that is RFID-enabled is used to read one or more RFID's of the item and automatically contact the appropriate service center. For example, a user may have questions regarding a particular item, such as his Brand X television. He/she simply moves an RFID-enabled communication device to the Brand X television (or visa versa) so that the RFID-enabled communication device can scan the RFID tag of the Brand X television. After the RFID-enabled communication device reads the RFID tag data, the communication device automatically contacts a service center for the Brand X television based on information in the obtained RFID tag data.

The communication device, such as a telephone or a computer network device, may take any form for contacting a service center (or the like). Whatever type of communication device is used, the user of the item is automatically connected with an agent at the appropriate service center or the like. When the agent then requests RFID information regarding the item, the user can then cause the RFID information to be automatically sent to the service center (e.g., by selected a “SEND” option).

Although the applications and scenarios illustrated below are mainly focused on techniques for contacting a service center for a consumer product and pushing RFID information to a service center in order to obtain service regarding such product, aspects of the present invention may be applied to other types of items, besides consumer products, and other types of applications where one may wish to share an item's RFID data with another entity. For instance, two individuals may wish to share their product information to determine whether they have a same or different product with the same or similar features. In another application, a person suffering from Alzheimer's disease may wish to use a communication device to call a help center regarding an RFID data tag located on the person (e.g., in an accessory). This RFID may then be matched with personal information, such as the person's home address or other information which the person needs help remembering. The application list for this invention is endless.

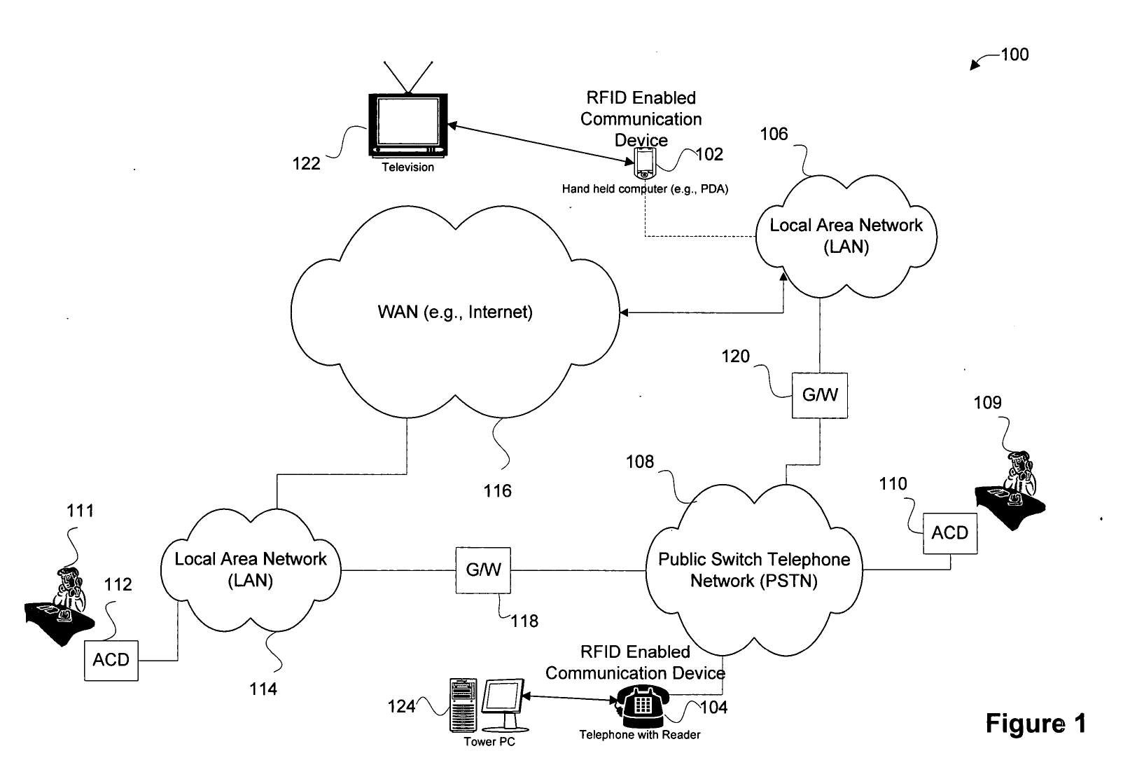

FIG. 1 is a diagrammatic representation of a network 100 in which techniques of the present invention may be implemented in accordance with one embodiment of the present invention. In general, a user may communicate with an agent at an Automatic Call Distribution (ACD) center using an RFID-enabled communication device. Each RFID-enabled communication device may take any suitable form for automatically connecting a user with an agent at an ACD center and/or sending RFID tag data to the ACD center. By way of examples, the RFID-enabled communication device may be an IP telephone integrated or coupled with a computer system, a stand-alone telephone (with or without a wire), a cell phone, a personal digital assistant (PDA), etc. The RFID-enabled communication device may include a separate or integrated RFID reader. A user communicates by using an RFID-enabled communication device that automatically connects to a selected ACD via any suitable type and number of network(s), such as a PSTN, cellular network, LAN, and/or WAN. As described further herein, the connection is made automatically based on RFID tag data from items that are proximate to the communication device (or RFID reader).

As shown, a first RFID-enabled communication device 104 is in the form of a telephone and a second RFID-enabled communication device 102 is in the form of a PDA. A user may use telephone 104 to communicate with an agent (e.g., 111) at a first ACD 112 via PSTN 108 and LAN 114 or with an agent (e.g., 109) at a second ACD 110 via PSTN 108. As shown, Gateway 118 handles calls between PSTN 108 and LAN 114. In one example, the user moves the telephone (wireless) 104 to a computer 124 having one or RFID tags and selects an option on the telephone 104 to automatically connect to the appropriate service center for such computer 124 (e.g., ACD 112) based on the computer's RFID tag data.

A user at another site may use PDA 102 to communicate with an agent (e.g., 111) at the first ACD 112 through LAN 106, WAN 116, and LAN 114 and with an agent (e.g., 109) at the second ACD 110 through LAN 106, and PSTN 108. Gateway 120 handles calls between PSTN 108 and LAN 106. In the illustrated example, the user moves the PDA 102 to a television 122 having one or RFID tags and selects an option on the PDA 102 to automatically connect the user to an agent at the service center (e.g., ACD 110) for such television 122 based on the television's RFID tag data.

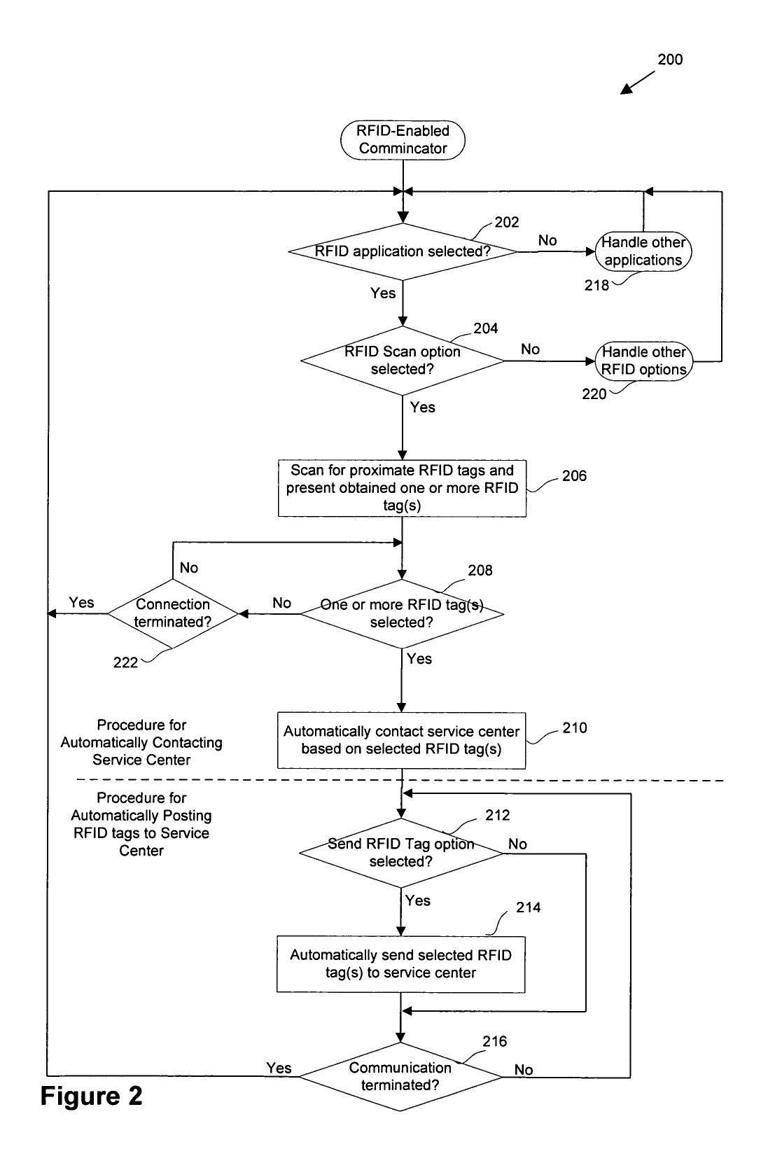

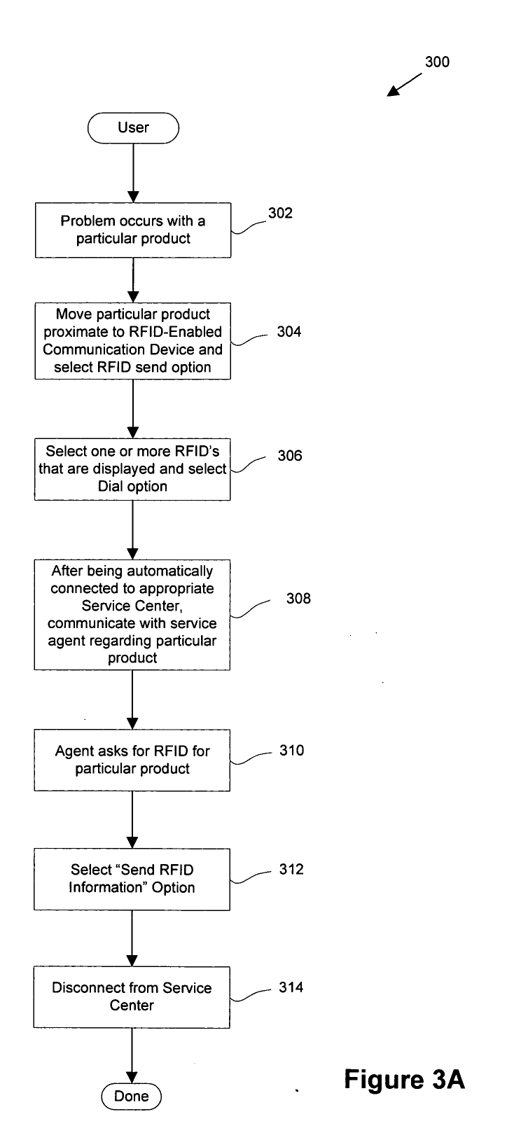

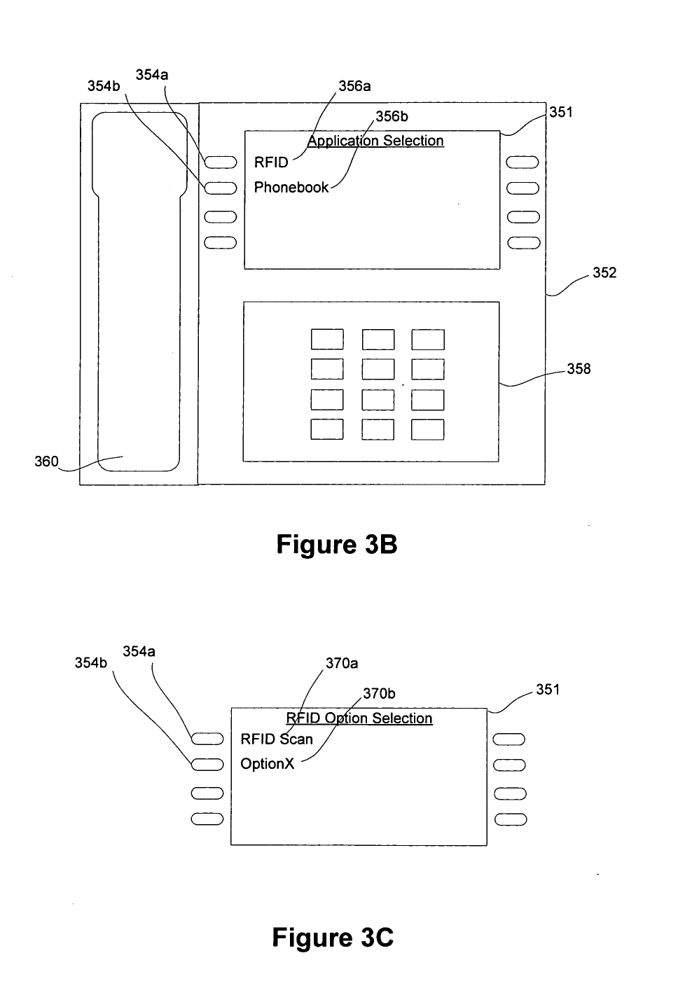

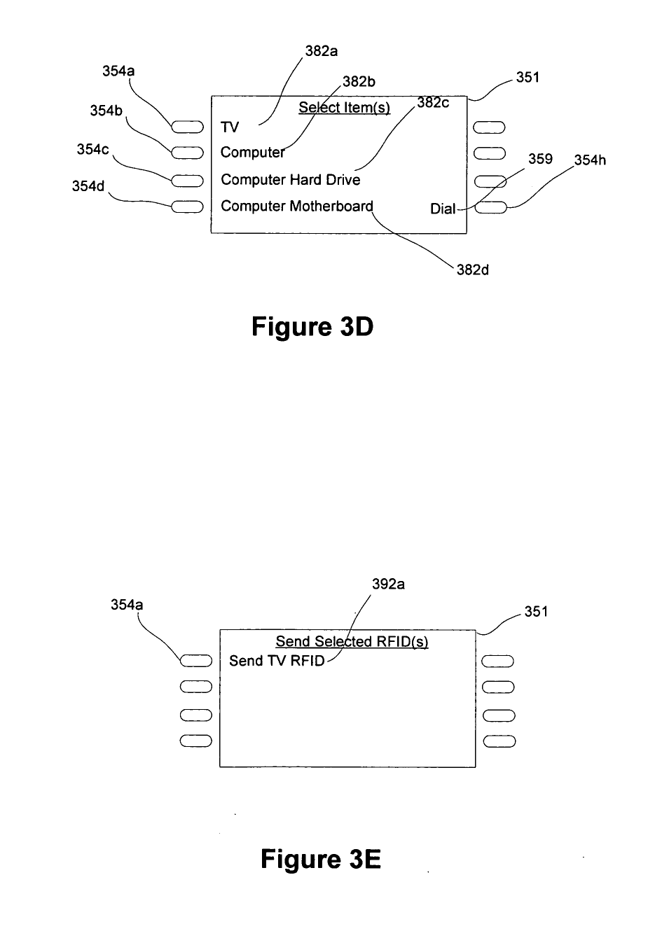

FIG. 2 is a flowchart illustrating a procedure 200 for automatically contacting a service center and automatically conveying RFID tag data to such service center in accordance with one implementation of the present invention. This procedure 200 can be implemented on any suitable type of RFID-enabled communication device, such a telephone or computer, that includes a coupled or integrated RFID reader. That is, this procedure 200 is configured (or programmed) within the communication device and such procedure 200 is designed to interact with a user that wishes to obtain services regarding one or more products through such communication device. FIG. 3A is a flowchart illustrating an example of actions performed by a user interacting with an RFID enabled communication device. The communication device procedure 200 of FIG. 2 will be described in conjunction with the user example of FIG. 3A.

The communication device operations of FIG. 2 may be divided into two separate, and possibly independent inventive procedures. A first set of operations 202-210 serve to automatically connect a user (or communication device) to a service center based on one or more RFID tags, while a second set of operations 212 and 214 include mechanisms for automatically pushing or sending RFID tags from a communication device to a service center. That is, the first set of operations may be implemented together or separately from the second set of operations, depending on the particular requirements of the application.

In the illustrated embodiment, it is initially determined whether an RFID application has been selected in operation 202. If an RFID application has been selected, it is then determined whether an “RFID scan” option has been selected in operation 204. However, if an RFID application has not been selected or an “RFID scan” option has not been selected, other applications or other RFID options are handled, respectively, in operations 218 and 220. The procedure 200 is then repeated.

In this implementation, it is assumed that the RFID-enabled communication device is configured with a plurality of other applications and/or RFID options, in addition to the options related to the present invention. However, the RFID-enabled communication device may simply be configured with options related to the RFID application of the present invention. In this case, it is only determined whether the “RFID scan” option has been selected without first determining whether the more general RFID application was selected. In sum, any suitable type and number of interface mechanisms may be utilized to implement selection operations in the present invention, besides the mechanisms described herein. Examples of input mechanisms include hardware button, dials, switches and levers, as well as a graphical user interfaces having selectable buttons, input boxes, pull-down menus, and/or writing input pads, etc, where options may also be selected by a mouse, stylus, keyboard, or voice command. Several different display configurations may also be utilized to present different menus to a user for facilitating selection of different applications and options.

FIG. 3B illustrates an RFID-enabled communication device 352 in the form of a telephone, while FIGS. 3C-3E illustrate different menus displayed on such telephone 352 in accordance with a specific implementation of the present invention. This particular configuration of a communication device is merely exemplary and does not limit the scope of the invention. As shown, the telephone 352 includes a handset 360, a keypad 358, a display 351, and a plurality of input buttons 354. The display 351 may be generally configured to display different selection menus. In this illustration, the display is presenting an “application selection” menu. Two application choices “RFID” 356a and “phone book” 356b are shown. In this implementation, the user selects an application by selecting the corresponding button 354. In the example of FIG. 3A, the user notices a problem with a particular product in operation 302. The user then moves the particular product proximate to an RFID-enabled communication device and selects the “RFID send” option in operation 304. Alternatively, the communication device is moved proximate to the particular product.

The user may first select the RFID application 356a by pressing the corresponding button 354a. The user may then be presented with an “RFID Option Selection” menu as illustrated in the display 351 of FIG. 3C. As shown, the user is presented with a list of selectable RFID options. In this example, two options are shown, an “RFID Scan” 370a and an “OptionX” 370b option. The user selects the RFID Scan option by pressing the corresponding button 354a.

Referring to communication device procedure of FIG. 2, when an “RFID scan” option is selected, the RFID tags which are proximate to the communication device are then scanned and the plurality of obtained RFID tags are then presented in operation 206. In one specific implementation, RFID tags are obtained within a 8˜10 feet radius of the communication device. That is, products having one or more RFID tag(s) and are located proximate to the communication device are all scanned to obtain all of their one or more RFID tag(s). For instance, a toaster oven may have a single RFID tag, while a computer system may have several RFID tags for each major component. When the communication device is brought proximate to the toaster (or the toaster is moved proximate to the reader), its single RFID tag is read and obtained. In contrast, when the communication device is moved proximate to the computer system (or visa versa), the communication device obtains all of the computer's associated RFID tags. When the communication device is proximate to both the toaster and the computer system, the communication device obtains the RFID tag of the toaster as well as the plurality of RFID tags of the computer system.

The RFID tags retrieved by the communication device are then displayed, for example, on the communication device's display screen. The obtained RFID tags may be displayed in any suitable format, such as a list of product names and/or RFID tags. In the example of FIG. 3D, a list of scanned products 382 are identified on the display 351 of the communication device in a “select item(s)” menu. After one or more RFID tags are obtained, it is then determined whether one or more RFID tag(s) have been selected in operation 208 of FIG. 2. For example, the user may select one or more RFID tag(s) by hitting one or more button(s) on the communication device that each correspond to a particular product and its corresponding RFID tag and then select a dial option as shown in operation 306 of FIG. 3A. In the example of FIG. 3D, the user may select the TV item 382a by pressing the corresponding button 354a and then select a dial option 359 by pressing the corresponding button 354h. Of course, the dial option (as well as other options) may also be selected via a completely hard input mechanism, such as a hard button that is labeled “dial” without a corresponding soft menu option being displayed in menu 351. In a specific implementation, if one or more RFID tag(s) have not been selected, it may then be determined whether the connection has terminated in operation 222 of FIG. 2. If a connection termination has occurred, the procedure 200 may be repeated. If a connection termination has not occurred, the procedure may then wait for one or more RFID tag(s) to be selected.

When one or more RFID tag(s) are selected before the connection is terminated, a service center based on the selected RFID tag(s) may then be automatically contacted in operation 210. Contacting a service center may include any of the following modes of communication: dialing a telephone number, loading a URL, sending an email, setting up an instant message session, etc. Several different communication devices and implementation of different communication modes are further discussed below. After contact is initiated, it is then determined whether a “send RFID tag” option has been selected in operation 212. If such an option has been selected, the selected RFID tag(s) (or portions of the selected tags) are then automatically sent to the service center in operation 214. If the “send RFID tag” option is not selected, this operation 214 is skipped. It is then determined whether communication has terminated in operation 216. If communication has not terminated, it may then be again determined whether the “send RFID tag” option has been selected. Otherwise the procedure 200 may be repeated where another RFID application is selected.

In the user example of FIG. 3A, after being automatically connected to the appropriate service center, the user then communicates with a service agent regarding the particular product in operation 308. The agent may then ask for the RFID tag for a particular product in operation 310. The “send RFID tag” option is then selected in operation 312. In the example of FIG. 3E, a “send selected RFID(s)” menu is presented to the user after automatically contacting the service center. The display 351 shows a “send TV RFID” 392a option based on the user's previous product selection. The user may send the RFID tag for the TV when needed by pressing the corresponding button 354a. The user then discusses his/her issue with the agent and after completing the discussion disconnects from the service center in operation 314.

In the illustrated embodiment, RFID tag data is pushed to the service center (or other entity) only when the user at the sending end initiates the push. Although not ideal, of course, the service center may alternatively extract the RFID tag directly from the communication device at the sending end without intervention from the user. This implementation has the disadvantage of allowing outside entities to reach inside a user's communication device to obtain information regarding proximate products without the user's consent. This situation has inherent privacy issues.

In one specific implementation, the user may grant the agent permission to remotely access the communication device of the user. To ensure the security of the system, the user preferably selects an “allow remote control” option (soft or hard input mechanism) to share his/her communication device screen and to allow control of his/her menu by the agent. This feature may allow users who are unable or unwilling to operate the communication device's menu and/or reader to obtain help from the service agent in performing any number of tasks on the communication device or reader. For example, the agent may directly select the RFID scan option on the communication device and then select the appropriate RFID from the scanned items. Also, sending of the selected RFID tags may include sending any suitable portion or all of the RFID tag.

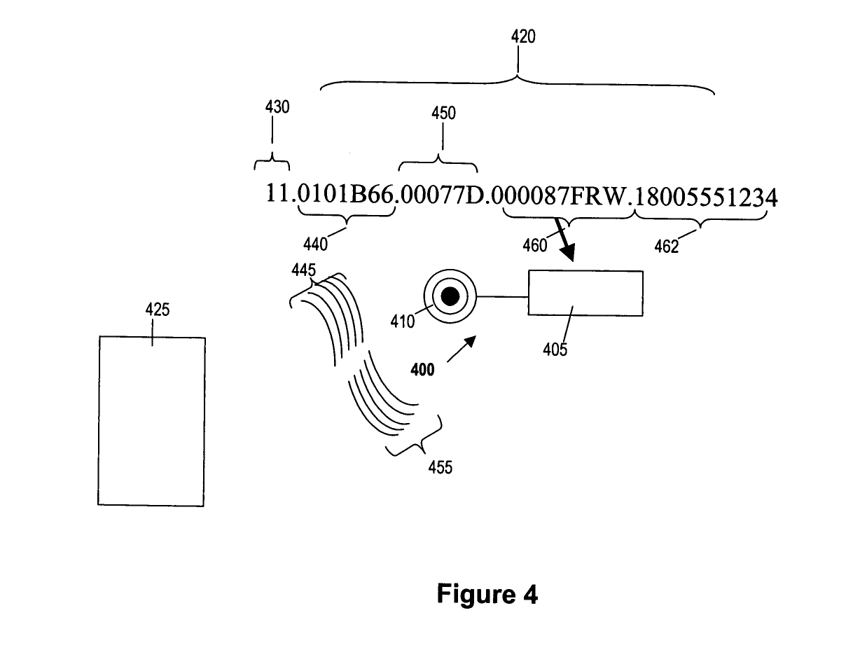

Many implementations of the present invention are based upon “smart labels,” generally implemented by radio frequency identification (“RFID”) tags. RFID tags have been used to keep track of items such as airline baggage, items of clothing in a retail environment, cows and highway tolls. As shown in FIG. 4, an RFID tag 400 includes microprocessor 405 and antenna 410. In this example, RFID tag 400 is powered by a magnetic field 445 generated by an RFID reader 425. The tag's antenna 410 picks up the magnetic signal 445. RFID tag 400 modulates the signal 445 according to information coded in the tag and transmits the modulated signal 455 to the RFID reader 425.

RFID tags use the Electronic Product Code (“EPC” or “ePC”) format for encoding information. An EPC code includes a variable number of bits of information (common formats are 64, 96 and 128 bits), which allows for identification of individual products as well as associated information. As shown in FIG. 4, EPC 420 includes header 430, EPC Manager field 440, Object class field 450, serial number field 460, and contact field 462 for the appropriate service center or the like. EPC Manager field 440 contains manufacturer information. Object class field 450 includes a product's stock-keeping unit (“SKU”) number. Serial number field 460 is normally a 40-bit field that can uniquely identify the specific instance of an individual product i.e., not just a make or model, but also down to a specific “serial number” of a make and model. The contact field includes information that will allow a communication device to contact a service center. The contact field may include one or more of the following types of contact information for a service center: 1-800 phone number, phone number, URL, email address, instant message address, IP address, MAC address, etc.

U.S. patent application Ser. No. 11/010,089, filed Dec. 9, 2004 and entitled “Methods and Devices for Providing Scalable RFID Networks” and U.S. patent application Ser. No. 10/866,285, filed Jun. 9, 2004 and entitled “Methods and Devices for Assigning RFID Device Personality” (collectively, the “RFID Network Applications”) contain relevant subject matter and are hereby incorporated by reference.

Generally, the techniques for contacting a service center and/or sending RFID data information to a service center of the present invention may be implemented by any suitable combination of software and/or hardware. For example, they can be implemented in an operating system kernel, in a separate user process, in a library package bound into network applications, on a specially constructed machine, or on a network interface card. In a specific embodiment of this invention, the techniques of the present invention are implemented in software such as an operating system or in an application running on an operating system.

A software or software/hardware hybrid packet processing system of this invention may be implemented on a general-purpose programmable machine selectively activated or reconfigured by a computer program stored in memory. Such programmable machine may be a network device designed to handle network traffic. Such network devices typically have multiple network interfaces including Ethernet, DSL, frame relay and ISDN interfaces, for example. A general architecture for some of these machines will appear from the description given below. In an alternative embodiment, one or more techniques of the present invention may be implemented on a general-purpose network host machine such as a personal computer or workstation. Further, the invention may be at least partially implemented on a card (e.g., an interface card) for a network device or a general-purpose computing device.

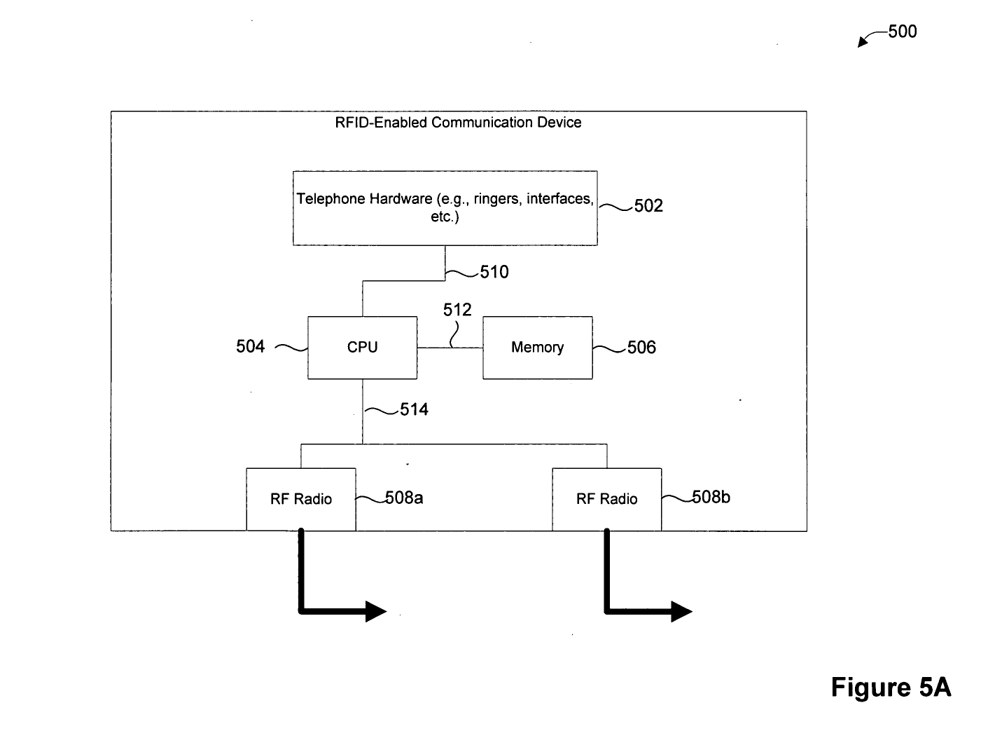

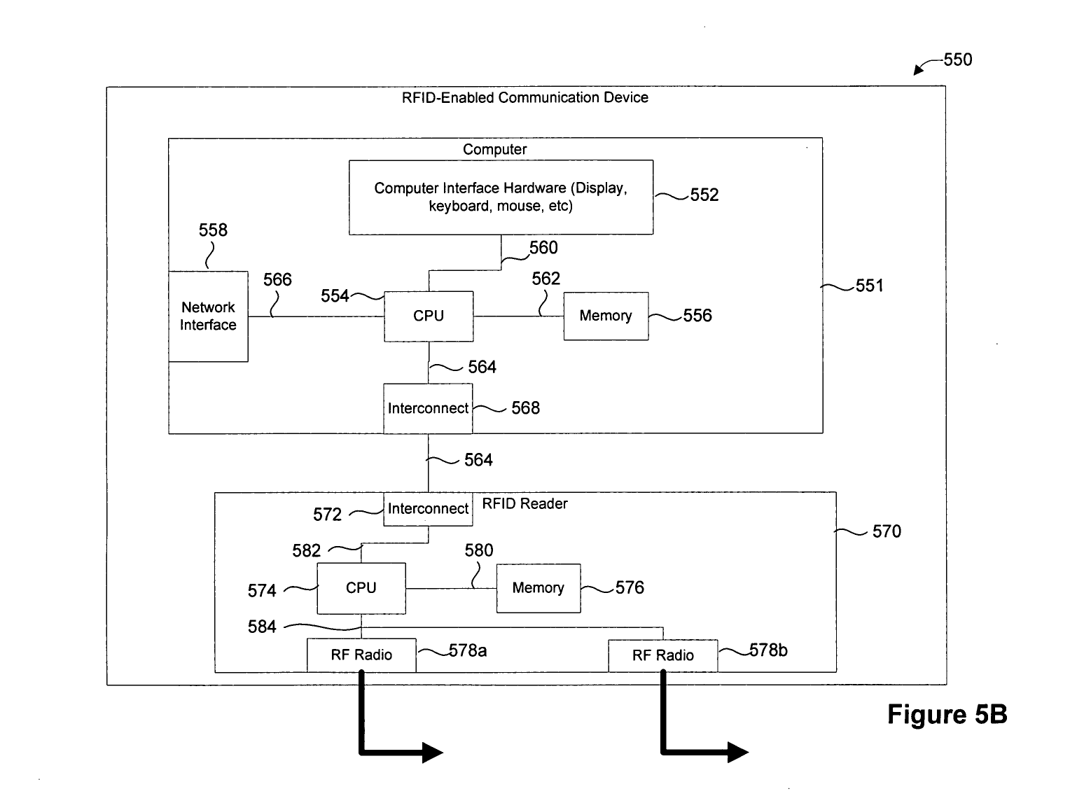

Referring now to FIG. 5A, an RFID-enabled communication device 500 in the form of a telephone suitable for implementing portions of the present invention (such as the automatic contact and RFID sending techniques) includes a central processing unit (CPU) 504 for controlling the operation of various components of the communication device 500, memory 506 for storing software instructions and data, telephone hardware 502, and one or more RF radios 508 for scanning or reading RFID tags that are proximate to the communication device. The telephone hardware includes any suitable number and type of components for implementing a telephone, such as speaker, microphone, ringer, duplex coil, interfaces (e.g., keypad, touchscreen, etc). The RF radios 508 may operate to transmit RF waves to and receive modulated RF waves from RFID tags. RF radios 508 provide raw RF data that is conveyed to or transmitted from CPU 504 and converted by an analog-to-digital converter (not shown). Any number of RF radios 508 may be utilized. In the illustrated example, a first RF radio 508a is configured as a transmitter, while a second RF radio 508b is configured as a receiver.

CPU 504 may include one or more processors, such as obtained from the Motorola family of microprocessors or the MIPS family of microprocessors. In an alternative embodiment, processor 504 is specially designed hardware for controlling the operations of communication device 500. In a specific embodiment, a memory 506 (such as non-volatile RAM and/or ROM) is in communication with or are integrated with CPU 504. However, there are many different ways in which memory could be coupled to the system. Memory block 506 may be used for a variety of purposes such as, for example, caching and/or storing data, programming instructions, etc.

Regardless of network device's configuration, it may employ one or more memories or memory modules (such as, for example, memory block 506) configured to store data, program instructions for the general-purpose network operations and/or the inventive techniques described herein. The program instructions may control the operation of an operating system and/or one or more applications, for example. The memory or memories may also be configured to store obtained RFID tag data, selected RFID tag data, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks and DVDs; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher level code that may be executed by the computer using an interpreter.

FIG. 5B is a diagrammatic representation of an RFID-enabled communication device 550 in the form of a computer 551 and RFID reader 570 in accordance with another embodiment of the present invention. Some of the components of this device 550 have a similar operation as some of the components of the device 500 of FIG. 5A. The computer 551 and reader 570 may be integrated together (as shown) or implemented in separate boxes. In one embodiment, the computer 551 and the reader each include their own CPU and memory. The CPU 554 of the computer 551 may operate to control components of the computer, while the CPU 574 of the reader serves to control components of the reader 570. However, it is understood that the RFID-enabled communication device 550 may include any suitable number and type of CPU's or controllers. Likewise, the RFID-enabled communication device 550 may include any suitable number and type of memory, such as computer memory 556 and reader memory 576. The reader 570 includes one or more RF radios 578 for handling RF signals communicated between RFID tags.

In this implementation, the computer portion 551 may be configured to implement a browser plug-in for presenting scanned product(s), as well as application and option menus to the user, for example, similar in operation to the telephone embodiment of FIGS. 3B-3E. In general, the user may be automatically connected to an agent of an ACD by any suitable communication mechanism, such as through a browser, email, instant messaging, etc. In the browser example, after the user selects one or more scanned items, a URL for a service center corresponding to the selected item(s) may be automatically loaded into the computer's browser. In the email example, an email to the corresponding service center's email address may be sent. An instant messaging session may also be set up between the computer of the user and the service center.

The communication device includes one or more interconnects (e.g., 568 and 572) for facilitating communication between the computer's CPU 554 and the reader's CPU 574. Interconnect 568 of computer 551 is configured for communication with interconnect 572 of RFID reader portion 570. In this example, interconnects 568 and 572 provide communication between computer 551 and reader 570. The communication may be via any convenient medium and format, such as wireless, serial, point-to-point serial, etc.

The computer portion 551 may include any suitable number and type of components typically found in a computer system, such as one or more memory 556, one or more processors 554, user interface hardware 552 (e.g., display, keyboard, mouse, etc.), and a network interface 558.

Network interface 558 may be any convenient type of interface, such as an Ethernet interface, for communicating with network (not shown). When acting under the control of appropriate software or firmware, the CPU 554 may also be responsible for such router tasks as routing table computations and network management. It may also be responsible for performing any combination of the above described techniques of the present invention. It preferably accomplishes all these functions under the control of software including an operating system (e.g., the Internetwork Operating System (IOS®) of Cisco Systems, Inc.) and any appropriate applications software.

The interfaces 558 are typically provided as Network Interface Cards (sometimes referred to as NIC's or “line cards”). Generally, they control the sending and receiving of data packets or data segments over the network and sometimes support other peripherals used with the communication device 550. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the microprocessor 554 to efficiently perform routing computations, network diagnostics, security functions, etc.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

What is claimed is:

1. A method of automatically contacting a support center for a particular item using the radio frequency identification (RFID) of the particular item, comprising:
using a radio frequency identification (“RFID”) reader, reading RFID tag data for a item; and
automatically contacting a service center that provides service for the item based on the reading of the RFID tag data for the item.

2. A method as recited in claim 1, further comprising:
reading RFID tag data for a plurality of items that are proximate to the RFID reader;
receiving a selection input for one or more item(s) selected from the items that are proximate to the RFID reader, and
automatically contacting a service center that provides service for the selected one or more item(s) based on the reading of the RFID tag data for the selected one or more item(s).

3. A method as recited in claim 1, wherein automatically contacting the service center is accomplished by connecting a communication device accessible by a user with an agent of the service center via a telephone network or a computer network, wherein the communication device includes or is coupled with the RFID reader.

4. A method as recited in claim 3, wherein automatically contacting the service center is accomplished by performing one or more tasks on the communication device that are selected from a group consisting of (i) automatically dialing a phone number of the service center, (ii) automatically loading a web page of the service center, (iii) automatically sending an email message to the service center, and (iv) automatically establishing an instant messaging session between the user and an agent of the service center.

5. A method as recited in claim 3, further comprising when the service center makes a request for RFID tag data, automatically sending the RFID tag data that was read for the item to the service center.

6. A method as recited in claim 5, wherein the RFID tag data is only sent after a user selects an option to send the RFID tag data.

7. A method as recited in claim 5, further comprising allowing the service center control of a menu of the communication device and the RFID reader after the user grants permission for such control.

8. A method as recited in claim 3, wherein the communication device is selected from a group consisting of a computer, a personal digital assistant, a telephone, a wireless phone, a cellular phone, a television, and a cable set top box.

9. A method as recited in claim 1, wherein the RFID tag data includes contact information selected from a group consisting of a telephone number, a URL (universal remote locator) address, and an email address.

10. A computer system operable to automatically contact a support center for a particular item using the radio frequency identification (RFID) of the particular item, the computer system comprising:
one or more processors;
one or more memory, wherein at least one of the processors and memory are adapted for:
using a radio frequency identification (“RFID”) reader, reading RFID tag data for a item; and
automatically contacting a service center that provides service for the item based on the reading of the RFID tag data for the item.

11. A computer system as recited in claim 10, wherein the at least one of the processors and memory are further adapted for:
reading RFID tag data for a plurality of items that are proximate to the RFID reader;
receiving a selection input for one or more item(s) selected from the items that are proximate to the RFID reader, and
automatically contacting a service center that provides service for the selected one or more item(s) based on the reading of the RFID tag data for the selected one or more item(s).

12. A computer system as recited in claim 10, wherein automatically contacting the service center is accomplished by connecting a communication device accessible by a user with an agent of the service center via a telephone network or a computer network, wherein the communication device includes or is coupled with the RFID reader.

13. A computer system as recited in claim 12, wherein automatically contacting the service center is accomplished by performing one or more tasks on the communication device that are selected from a group consisting of (i) automatically dialing a phone number of the service center, (ii) automatically loading a web page of the service center, (iii) automatically sending an email message to the service center, and (iv) automatically establishing an instant messaging session between the user and an agent of the service center.

14. A computer system as recited in claim 10, wherein the at least one of the processors and memory are further adapted for automatically sending the RFID tag data that was read for the item to the service center when the service center makes a request for RFID tag data.

15. A computer system as recited in claim 14, wherein the RFID tag data is only sent after a user selects an option to send the RFID tag data.

16. A computer system as recited in claim 14, wherein the at least one of the processors and memory are further adapted for allowing the service center control of a menu of the communication device and the RFID reader after the user grants permission for such control.

17. A method as recited in claim 12, wherein the communication device is selected from a group consisting of a computer, a personal digital assistant, a telephone, a wireless phone, a cellular phone, a television, and a cable set top box.

18. A method as recited in claim 10, wherein the RFID tag data includes contact information selected from a group consisting of a telephone number, a URL (universal remote locator) address, and an email address.

19. An apparatus for automatically contacting a support center for a particular item using the radio frequency identification (RFID) of the particular item, comprising:
means for using a radio frequency identification (“RFID”) reader, reading RFID tag data for a item; and
means for automatically contacting a service center that provides service for the item based on the reading of the RFID tag data for the item.

20. An apparatus as recited in claim 19, further comprising:
means for reading RFID tag data for a plurality of items that are proximate to the RFID reader;
means for receiving a selection input for one or more item(s) selected from the items that are proximate to the RFID reader, and
means for automatically contacting a service center that provides service for the selected one or more item(s) based on the reading of the RFID tag data for the selected one or more item(s).
